(19) United States
(12) Patent Application Publication
(10) Pub. No.: US 2003/0083051 A1
(43) Pub. Date: May 1, 2003

(54) Mobile telecommunications device

(76) Inventor: Peter Ntende, Copenhagen (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/984,824

(22) Filed: Oct. 31, 2001

(51) Int. Cl. H04M 3/42; H04M 1/00

(52) U.S. Cl. 455/414; 455/566; 455/567

(57) ABSTRACT

A mobile telephone handset, which is also known as a cellular telephone handset, provides a timetable for schools and colleges. The timetable is suitable for storing the time, identity and location of classes, lessons or lectures and other events such as break and lunch periods. The handset receives information relating to a pattern of events and generates the timetable by repeating the pattern by mapping a given calendar day onto a corresponding day comprised in the pattern.

### FIELD OF THE INVENTION

The present invention relates to a mobile telecommunications device.

### BACKGROUND ART

Conventional mobile telecommunications devices such as mobile telephone handsets, often provide supplementary features and applications which are of assistance to users.

One such feature is a calendar. A user can write and view notes for each day in the calendar. They can specify a time for an event occurring on a particular day and arrange to be reminded of the event using an alarm.

Although such calendars are flexible, they do not easily accommodate a pattern of events which is repeated on a periodic basis, such as in a school timetable. Thus, if a pattern of events recur on a weekly, bi-weekly or monthly basis, the user has little option but to re-enter the events for each week they occur.

The present invention seeks to help solve this problem.

### SUMMARY OF THE INVENTION

According to the present invention there is provided a mobile telecommunications device configured to provide a school timetable whereby the device receives information relating to a pattern of events and generates said timetable by repeating said pattern.

The pattern of events may include events occurring on weekdays only. The pattern of events may occur within a timeframe of week and be repeated every week. The pattern of events may occur within a timeframe of two weeks and be repeated every two weeks.

The information may comprise a set of data relating to each respective event. Each set of data may include data relating to a time at which said event occurs, data relating to an identity of said event, data relating to a location at which said event occurs, data relating to an alarm and data for helping to identify said event.

The sets of data may be stored sequentially in a memory.

The device may generate said timetable by mapping a given calendar day onto a corresponding day comprised in said pattern. The device may generate said timetable by repeatedly copying said information in memory so as to produce a contiguous sequence of repeated patterns.

The timetable may be timetable for an educational establishment. For example, the timetable may be a school timetable and the pattern of events may include lessons and free periods including break times.

The pattern may be repeated contiguously.

The device may be a mobile telephone handset.

According to the present invention there is also provided a method of providing a school timetable in a mobile telecommunications device, the method comprising receiving information relating to a pattern of events and generating said timetable by repeating said pattern.

The generating of said timetable may comprise mapping a given calendar day onto a corresponding day comprised in said pattern. The generating of said timetable may comprise repeatedly copying said information in memory so as to produce a sequence of repeated patterns.

According to the present invention there is still further provided a computer program including instructions for carrying our the method.

According to the present invention there may be still further provided a method of operating a mobile telecommunications device configured to provide a timetable, the method comprising providing information relating to a pattern of events and instructing said device to generate said timetable by repeating said pattern.

### BRIEF DESCRIPTION OF THE DRAWINGS

An embodiment of the present invention will now be described, by way of example, with reference to the accompanying drawings in which:

FIG. 1 shows a mobile telephone handset;

FIG. 2 is a schematic diagram of telephone circuitry;

FIG. 3 shows a front face of the handset shown in FIG. 1;

FIG. 4 is a flow diagram showing how an entry is made in a timetable;

FIGS. 5a, 5b, 5c and 5d each show a display on the handset during the process of making an entry in the timetable;

FIG. 6 is a flow diagram showing how periodicity of a timetable is set;

FIGS. 7a and 7b each show a display on the handset during the process of changing a current day to be viewed;

FIG. 8 is a flow diagram showing customisation of the timetable;

FIGS. 9a and 9b each show a display on the handset during the process of customisation of the handset;

FIG. 10 is flow diagram showing a process by which a user is alerted that the timetable is out of date; and

FIG. 11 shows how data related to the timetable is stored in a flash memory.

### PREFERRED EMBODIMENT OF THE INVENTION

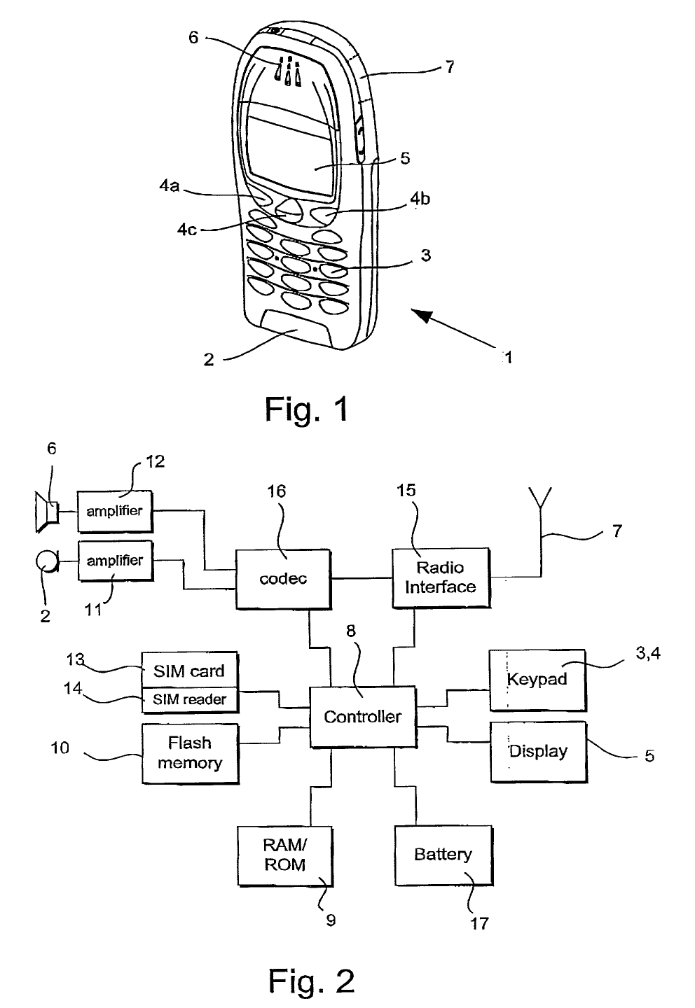

Referring to FIG. 1, a mobile telephone handset 1, sometimes referred to as a cellular telephone handset, includes a microphone 2, keypad 3, soft keys 4, a liquid crystal display 5, speaker 6 and internal antenna 7. The handset 1 conforms to a 2^{nd} generation (2 g) recommendation, such as GSM. However, it will be appreciated that the handset 1 may conform to other recommendations, such as those used for 2½-g and 3 g applications.

The circuitry of the handset 1 is shown in more detail in FIG. 2. Signal processing is carried out under the control of a digital microcontroller 8 which has an associated RAM/ROM 9 and flash memory 10. Electrical analogue audio signals ate produced by the microphone 2 and amplified by a pre-amplifier 11. Similarly, analogue audio signals are fed to the speaker 6 through an amplifier 12. The microcontroller 8 receives instruction signals from the keypad 3 and so-called soft keys 4a, 4b, 4c and controls operation of the LCD 5 and flash memory 10.

Information concerning the identity of the user is held on a smart card 13 in the form of a GSM SIM card which contains the usual GSM international mobile subscriber identity and encryption Kᵢ that is used for encoding the radio transmission in a manner well known per se. The SIM card 13 is removably received in a SIM card holder 14. Radio signals are transmitted and received by means of the antenna 7 connected through a r.f. stage 15 to a codec 16 configured to process signals under the control of a microcontroller 8.

Thus, in use, for speech, the codec 16 receives analogue signals from the microphone amplifier 11, digitises them into a form suitable for transmission and feeds them to the rf stage 15 for transmission through antenna element 7 to a PLMN (not shown). Similarly, signals received from the PLMN (not shown) are fed through the antenna element to be demodulated by the rf stage 15 and fed to codec 16 so as to produce analogue signals fed to amplifier 12 and speaker 6.

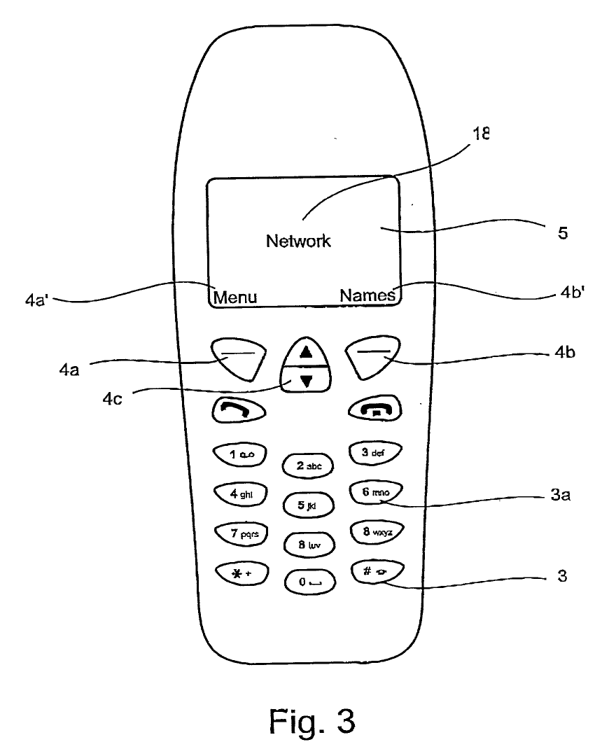

Referring to FIG. 3, the keypad 3 and soft keys 4a, 4b, 4c are used to supply instructions for controlling functions and applications provided by the handset 1. The result of pressing one of the soft keys 4a, 4b, 4c depends on the state of the handset 1a and is indicated by text 4a′, 4b′ displayed on the LCD 5. For example, in FIG. 3, the handset 1 is in an idle state and indicates the identity 18 of a network provider. In this state, actuation of soft key 4a, hereinafter referred to as the first soft key 4a, accesses a function menu. Actuation of soft key 4b, hereinafter referred to as the second soft key 4b, opens an address book. Functions can be selected and names found by scrolling through the function menu and address book respectively using the soft key 4c, hereinafter referred to as the scroll key 4c. Alphanumeric data is entered using the keypad 3. For example, the letter “n” is entered by repeated action of “6 mno” key 3a.

The handset 1 provides a calendar function which is well known in the art. Additionally or alternatively, the handset 1 provides a timetable, such as a timetable for an educational establishment such as a school, college or university.

The timetable is suitable for storing the time, identity and location of classes, lessons or lectures and other events such as break and lunch periods. The timetable is periodic on a weekly, biweekly or monthly basis. For example, a student may have a maths lesson at 8 am every Monday. The timetable is configured to accommodate this schedule without the need for making repeated entries.

Making Entries in the Timetable

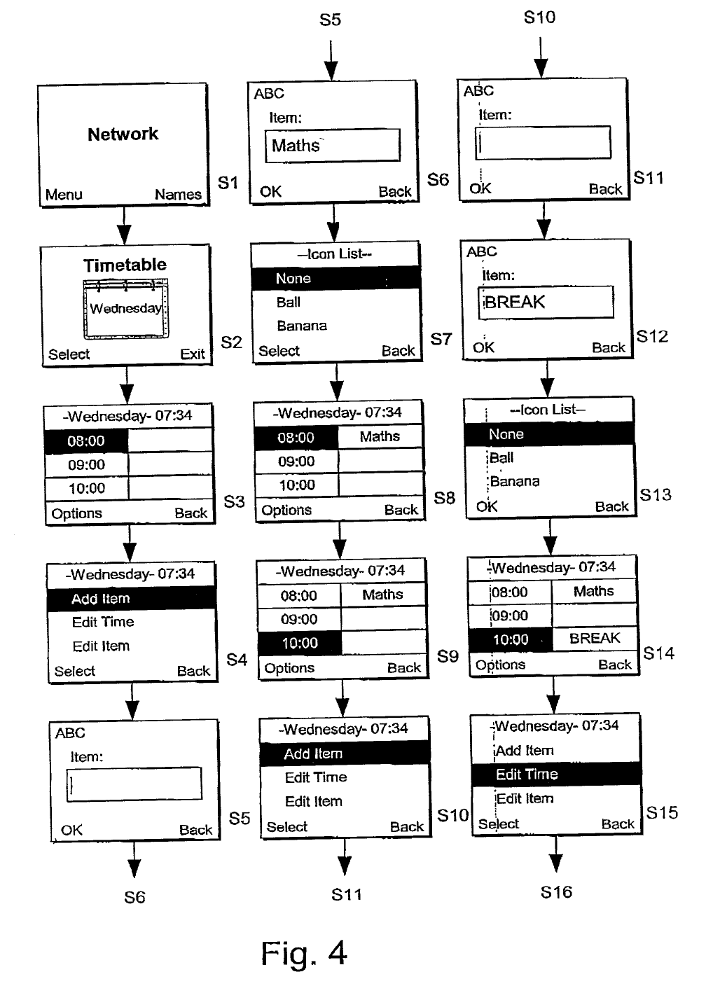

Referring to FIG. 4, the handset 1 is in an idle state waiting for input from a public land mobile network (PLMN) or a user (step S1). In the idle state, the first soft key 4a (FIG. 3) is associated with text “Menu” displayed on the LCD 5 (FIG. 3) and second soft key 4b is associated with text “Names”. The user presses the first soft key 4a to enter a main menu which lists a plurality of functions and repeatedly presses the scroll key 4c until they find “Timetable” (step S2). The user activates the first soft key 4a to enter the timetable function. The microcontroller 8 identifies what the current calendar day is, determines what timetable day this corresponds to, retrieves the timetable from flash memory 10 and displays the timetable for that day on the LCD 5 (step S3).

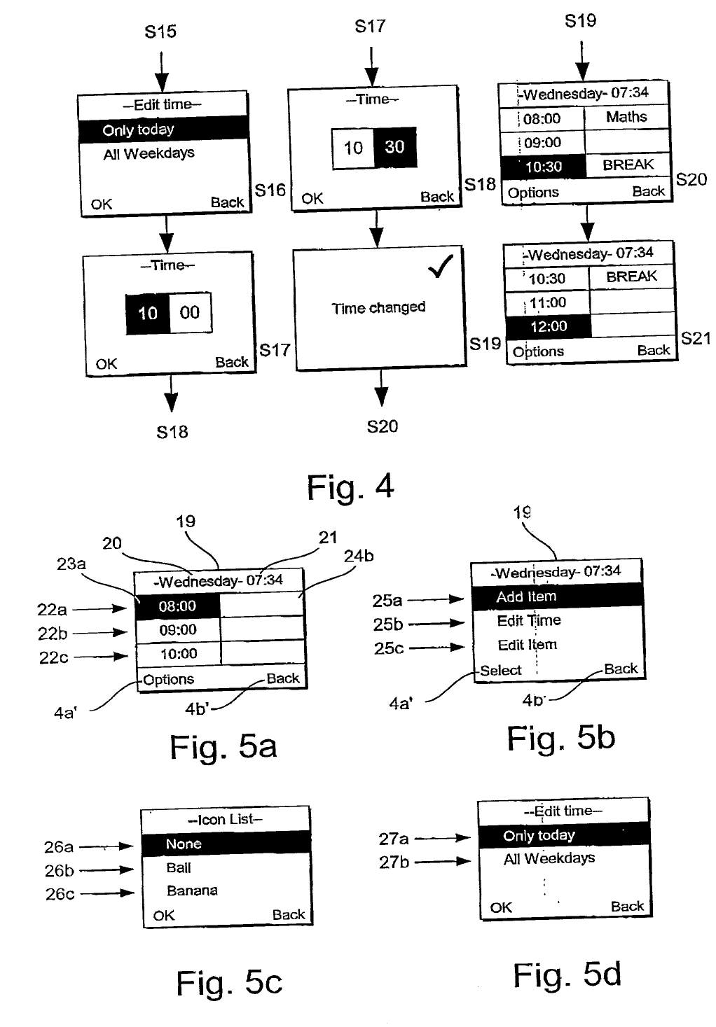

As shown in FIG. 5a, only a part of the day's timetable is displayed and includes a header 19, identifying the timetable's displayed day 20 and current time 21, and rows 22a, 22b, 22c of entries. Each row 22 includes a time entry 23 and an item entry 24 The time 23a of the first entry 22a shows “08:00” and is highlighted, as shown by the dark shading. The text entry 24a is currently blank. The LCD 5 also provides first and second soft key options 4a′, 4b′, namely “Options” and “Back” respectively.

Referring again to FIG. 4, the user presses the fist soft key 4a to select “Options” (step S3).

As shown in FIG. 5b, the user is presented with a plurality of options 25. The options 25 include add item 25a, edit time 25b, edit item 25c, settings 25d (FIG. 7a), add location 25e (FIG. 7a), select another day 25f (FIG. 7a) and erase item (not shown). Each option is selectable using the scroll key 4c and first soft key 4a.

Referring again to FIG. 4, the user presses the first soft key 4a to select “Add item” option 25a (step S4). The user is presented with a text editor for entering and editing text using the keypad 3 (step 5S). The user enters “Maths” and then presses the first soft key 4a to indicate that they have finished entering text (step S6).

Referring to FIG. 5c, the user can select any one of a plurality of icons 26 to display with the text. In this example, the user does not select an icon.

Referring again to FIG. 4, the user has now made an entry indicating that they have a maths lesson starting at 08:00 every Wednesday (step S8). The entry is stored in flash memory 10, the organisation of which will be described in more derail later. The user can then continue to maker further entries and a further example of making an entry and altering its properties will now be described.

The user scrolls down to the third entry for 10:00 (step 59) and in a similar manner to steps S4 to S7 above makes another entry (steps S10 to S13). However, the user enters “BREAK” instead of “Maths”.

The handset 1 presents a user with a timetable having one-hour periods. However, the user can alter this. The user presses the first soft key 4a to select “Options” (step S14) and scrolls down the list of options 25 and selects “Edit time” (step S15).

Referring to FIG. 5d, the user is presented with an option 27a to alter the time for the current day only and an option 27b to alter the time for the whole week. The user selects current day only by pressing the first soft key 4a (step S16).

Referring again to FIG. 4, the user is presented with the time with hours portion highlighted (step S17). The user presses the scroll key 4c to shift the highlight to minutes portion and using the keypad 3 enters “3” and then “0” (step S18). The user indicates that they are satisfied with the entry by pressing the first soft key 4a, the handset 1 confirms that the time has been changed (step S19) and returns to the timetable display which shows an altered start time, i.e. 10:30 (step S20). If the user wishes, to enter further items then they press the scroll key 4c to access other tunes of the day (step S21).

It will be appreciated that the user can add further entries. Moreover, by selecting “Edit item”, they can alter entries using the text editor.

Viewing Other Days

Whenever the timetable is viewed, the timetable for the day corresponding to the current calendar day is displayed. Nevertheless, it will be appreciated that any day of the week may be set as a default, such as Monday, so that whenever the timetable is viewed it always shows Monday's timetable. However, the user may want to view day either to inspect the timetable or to enter items.

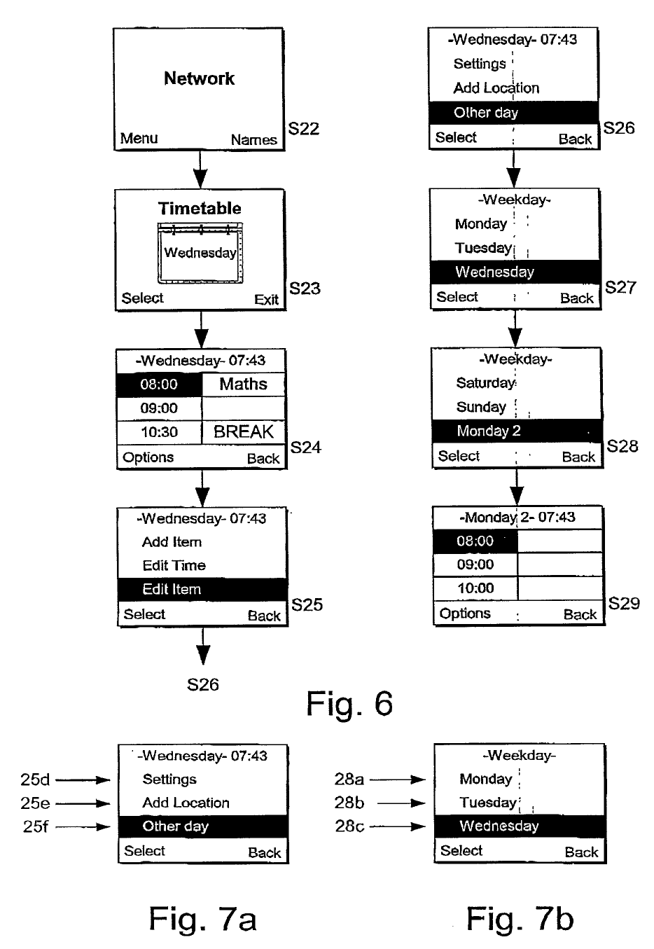

Referring to FIG. 6, the handset 1 is in an idle state waiting for input from the network or the user (step S22). The user presses the first soft key 4a to enter a main menu, then finds and selects “Timetable” (step S23). The microcontroller 8 identifies what calendar day it is, determines a corresponding timetable day, retrieves the timetable from flash memory 10 and displays the timetable for that day (step S24).

The user presses the first soft key 4a to select “Options” and, using the scroll key 4c, moves down the list of options 25 (FIG. 5b) (step S25). The highlight moves down the list until it reaches the bottom of the list of options displayed on the LCD 5.

Referring to FIG. 7a, further actuation of the scroll key 4c downwards causes the list to scroll upwards, removing the option at the top of the list adding a further option to the bottom. Thus, actuation of the key causes “Add item” to be removed and “Settings” to be added. Further actuation of the key 4c causes “Edit time” to be removed and “Add Location” to be added. Still further actuation of the key 4c causes “Edit item” to be removed and “Other day” to be added to the bottom of the display list and the resulting display list is shown in FIG. 7a.

Referring again to FIG. 6, the user then presses the first soft key 4a to select “Other day” (step S26).

Referring to FIG. 7b, the user is presented with list of days 28, including Monday 28a, Tuesday 28b and Wednesday 28c. The user repeatedly presses the scroll key 4c to scroll through the days of week. In this example, the timetable is bi-weekly, i.e. repeats itself every 2 weeks, and so once the user has scrolled through the days of a week, they can scroll through the days of a second week.

Referring again to FIG. 6, the user presses the scroll key 4c until they reach “Monday 2”, namely an entry for Monday of the second week (steps S27 & S28) and presses the first soft key 4a to select that day. Accordingly, the timetable for Monday 2 is retrieved from memory 10 and displayed on the LCD 5 (step S29).

It will be appreciated that this procedure can be used to select any day of the calendar. The use can view entries by using the scroll key 4c and select “Option” and then “Add Item” or “Edit Item” to add or edit the name of a lesson.

Customising the Timetable

To avoid the need for re-entering items, the timetable is customisable to set its periodicity. Furthermore, the user can also set the duration for which the timetable is valid.

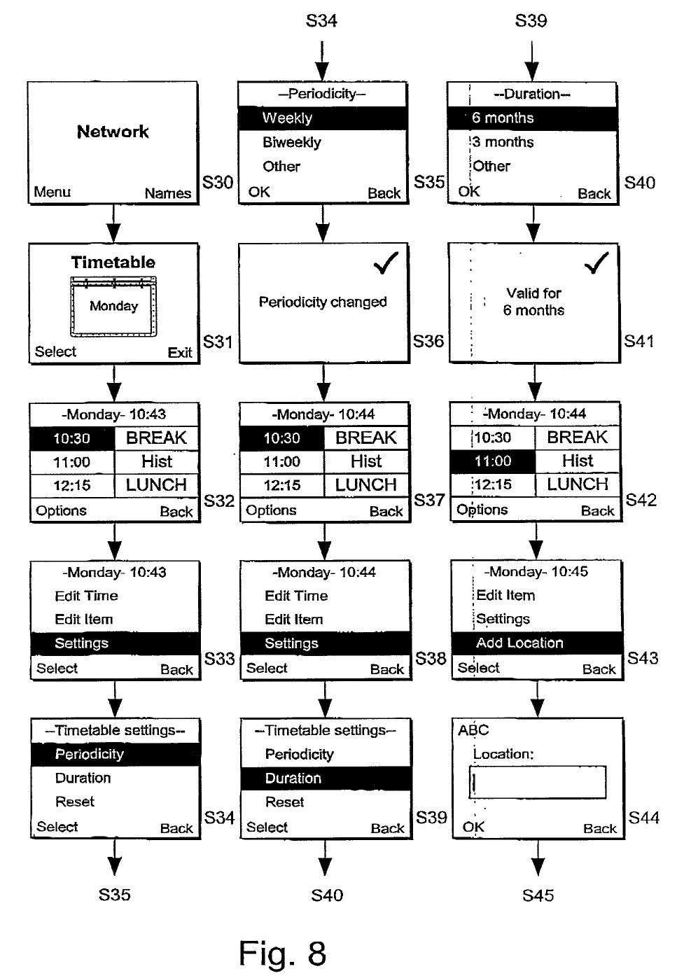

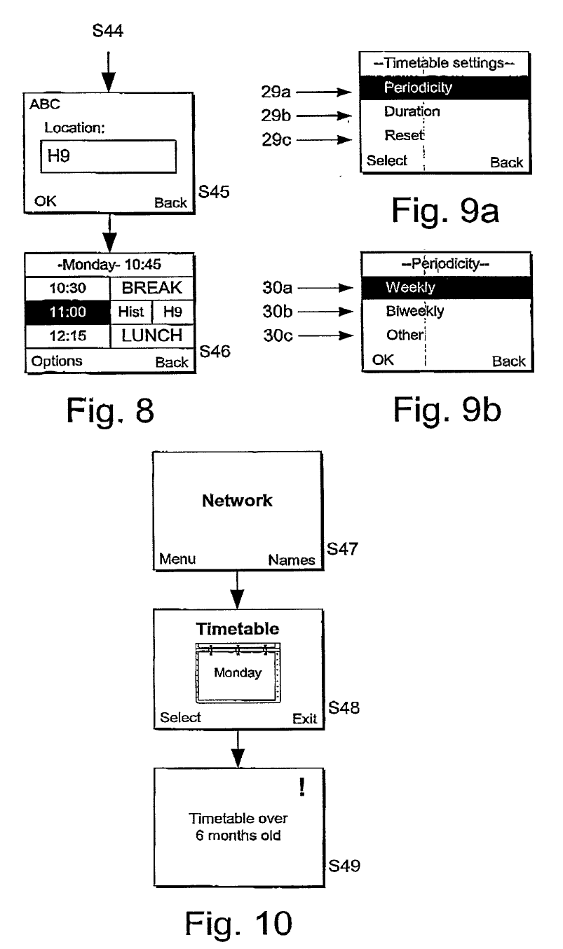

Referring to FIG. 8, the handset 1 is in an idle state waiting for input from the network or the user (step S30). The user presses the first soft key 4a to enter a main menu, then finds and selects “Timetable” (step S31). The microcontroller 8 identifies what day it is, retrieves the timetable from flash memory 10 and displays the timetable for that day, in is example Monday (step S32).

The user presses the first soft key 4a to select “Options” and, using the scroll key 4c, moves down the list of options 25 (FIG. 5b) until they reach “Settings” 25d (FIG. 7a) and then presses the first soft key 4a to select this option (step S33).

Referring to FIG. 9a, the user is presented with a plurality of settings options 29. The options 29 include “Periodicity” 29a, “Duration” 29b and “Reset” 29c.

Referring again to FIG. 8, the user presses the first soft key 4a to select “Periodicity” option 29 (step S34).

Referring to FIG. 9b, the user is faced with periodicity options 30 including “Weekly” 30a, “Biweekly” 30b and an-option “Other” 30c for providing a user-defined periodicity.

Referring again to FIG. 8, the user selects “Weekly” by pressing the first soft key 4a (step S35). The microcontroller 8 receives a signal from the soft key 4a and writes periodicity data to the flash memory 10. Thus, in this example the microcontroller 8 configures the flash memory 10 to store a week's worth of timetable. If a longer periodicity is selected, then the microcontroller 8 configures the flash memory 10 to store more than a week's worth of timetable. Once data has been stored, the handset 1 confirms that periodicity has been set (step S36) and then returns to the timetable display (step S37).

When the user selects a timetable which is periodic on a weekly basis, the step of determining which timetable day corresponds to the given calendar day is straightforward. The microcontroller 8 need only determine which day of the week it is and retrieve the timetable for that day of the same name.

If the user selects a timetable which is periodic on a multiple-weekly basis, such as biweekly, the microcontroller 8 maps any given calendar day onto a corresponding day comprised in the multiple of weeks. This is calculated using the start date of the timetable.

The timetable will usually only be valid for a term, semester or academic year. Therefore, it is useful to set the duration of the timetable.

Referring still to FIG. 8, the user presses the first soft key 4a to select “Options” and, using the scroll key 4c, moves down the list of options 25 and selects “Settings” (step S38). Thereafter, the user scrolls down the list of timetable settings 29 and selects “Duration” option 29b (step S39). The user is then presented with intervals of time, namely 6 months, 3 months and an option “Other” for entering a user-defined duration (step S40). The user selects 6 months. The handset 1 confirms that the duration has been set (step S41) and goes back to the timetable display (step S42).

The consequence of setting the duration will be described in more detail later.

The timetable also allows the user to enter further information regarding an entry, such as location of a lesson.

The user presses the first soft key 4a to select “Options” and, using the scroll key 4c, moves down the list of options 25 and selects “Add location” (step S43). The user is presented with a text editor for entering and editing text using the keypad 3 (step S44). The user enters “H9” and then presses the first soft key 4a to indicate that they have finished entering text (step S45). The timetable is then presented showing the location of the class (step S46).

Referring to FIG. 10, if the user attempts to view a timetable (step S47 & S48) and the timetable is no longer valid, then the user is alerted to this fact (step S49).

Timetable Storage

As explained earlier, the microcontroller 8 is in charge of writing data to and reading data from the flash memory 10.

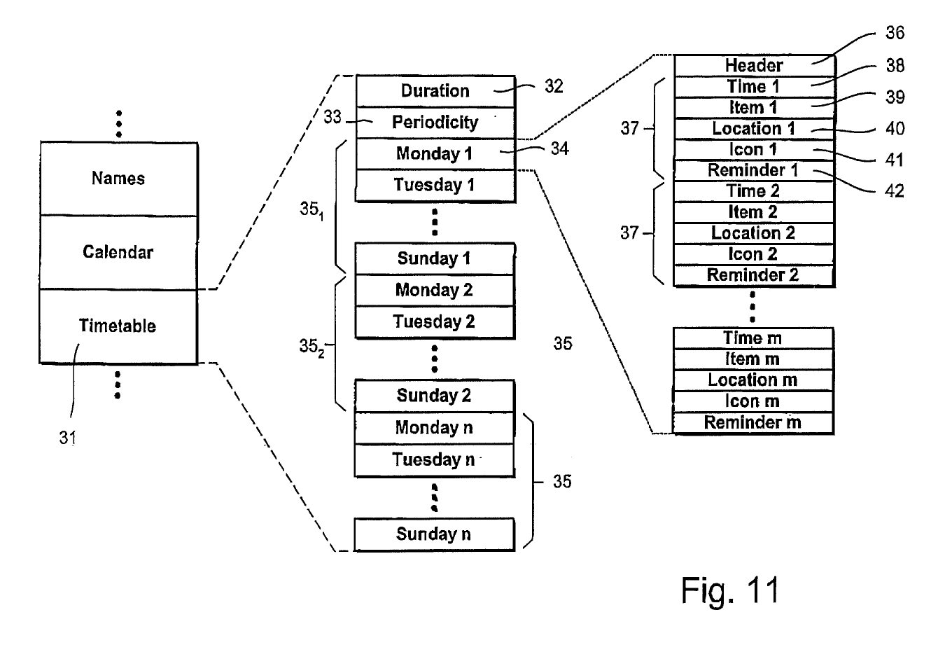

Referring to FIG. 11, the timetable is stored in the flash memory 10. A block 31 of memory is reserved for the timetable. The block 31 begins with a header including data 32 relating to the duration of the timetable, including a start date, and data specifying the periodicity 33. In this example, the periodicity is an integer, n, corresponding to the number of weeks in the cycle. Therefore, timetables which repeat every week or every two weeks have values n=1 and n=2 respectively. After the general data, specific data for each day 34 of each week 35₁, 35₂ within the cycle is stored. Data relating to each day 34 comprises a header 36 relating to day-specific information, such as the number of sets of entries and a plurality of sets 37 of entries. Each set 37 includes a time 38, item string 39, location string 40, data relating to an icon 41 and data relating to a reminder 42.

The microcontroller 8 performs a simple calculation to determine which day 34 of which week 35 to retrieve to be retrieved or stored.

The start date held in the header 32 is used to determine the calendar week C₁ which corresponds to the first week in a cycle. For example, if the start date is Monday Sep.17, 2001, then C₁=38. A given calendar date is used to determine a calendar week C₂. The given calendar date can be the current day or a day specified by the user. For example, if the given date is Tuesday Oct. 8, 2001, then C₂=41. If the timetable is biweekly, then n=2.

To calculate the timetable week, W, the following equation is used:

W=1+((C₂-C₁)mod n)

Thus, if C₁=38, C₂=41 and n=2, then W=2. Therefore, the microcontroller 8 retrieves data for Tuesday 2 which occurs in week 35₂.

Those skilled in the art will understand that the microcontroller 8 may load and run software to operate the timetable function.

It will be appreciated that many modifications may be made to the embodiment described above. For example, the timetable may be incorporated into calendar.

The timetable may be generated by storing the pattern of events as repeated blocks in memory.

A complete or partially complete timetable may be downloaded from a source. The download may be done over a wired or wireless link. For example, an infrared data link, Bluetooth transceiver or the handset's telecommunications link may be used. The timetable can be sent using a so-called “over the air” feature which is currently used to send ring tones, screen savers and other profiles to the handset. The timetable can be distributed by a school or college or by the users themselves and be sent to individual users or a group of users.

The timetable can be stored in RAM/ROM or in a removable memory card. If a removable memory card is used, the timetable may be preinstalled. It will be appreciated that the timetable may be partially customisable. Thus, some elements, such as times and classes, may be fixed, while other elements, such as reminders and icons, may be altered by the user.

The days of the week may differ. For example, a week may be taken to start on a day other than Monday, for example Sunday. A week may consist of fewer than seven days. For example, the timetable may ignore weekends and so the week consists of only five days.

1. A mobile telecommunications device configured to provide a timetable whereby the device receives information relating to a pattern of events and generates said timetable by repeating said pattern.

2. A device according to claim 1, wherein said pattern of events includes events occurring on weekdays only.

3. A device according to claim 1, wherein the pattern of events occurs within a timeframe of week.

4. A device according to claim 3, wherein said pattern of events is repeated every week.

5. A device according to claim 1, wherein the pattern of events occurs within a timeframe of two weeks.

6. A device according to claim 5, wherein said pattern of events is repeated every two weeks.

7. A device according to claim 1, wherein said information comprises a set of data relating to each respective event.

8. A device according to claim 7, wherein said each set of data includes data relating to a time at which said event occurs.

9. A device according to claim 7, wherein said each set of data includes data relating to an identity of said event.

10. A device according to according to claim 7, wherein each set of data includes data relating to a location at which said event occurs.

11. A device according to claim 7, wherein each set of data includes data relating to an alarm.

12. A device according to claim 7, wherein each set of data includes data for helping to identify said event.

13. A device according to claim 7, wherein sets of data are stored sequentially in a memory.

14. A device according to claim 1, wherein said device generates said timetable by mapping a given calendar day onto a corresponding day comprised in said pattern.

15. A device according to claim 1, wherein said device generates said timetable by repeatedly copying said information in memory so as to produce a contiguous sequence of repeated patterns.

16. A device according to claim 1, wherein said timetable is timetable for an educational establishment.

17. A device according to claim 16, wherein said timetable is a school timetable.

18. A device according to claim 17, wherein said pattern of events include lessons.

19. A device according to claim 18, wherein said pattern of events includes free periods.

20. A device according to claim 19, wherein said free periods include break times.

21. A device according to claim 1, wherein said pattern is repeated contiguously.

22. A device according to claim 1, which is a mobile telephone handset.

23. A method of providing a school timetable in a mobile telecommunications device, the method comprising:
receiving information relating to a pattern of events and
generating said timetable by repeating said pattern.

24. A method according to claim 23, wherein said generating of said timetable comprises mapping a given calendar day onto a corresponding day comprised in said pattern

25. A method according to claim 23, wherein said generating of said timetable comprises repeatedly copying said information in memory so as to produce a sequence of repeated patterns.

26. A computer program including instructions for carrying out the method claimed in claim 23.

27. A method of operating a mobile telecommunications device configured to provide a timetable, the method comprising:
providing information relating to a pattern of events and
instructing said device to generate said timetable by repeating said pattern.
